(19) United States
(12) Patent Application Publication
(10) Pub. No.: US 2016/0349931 A1
(43) Pub. Date: Dec. 1, 2016

(54) RESPONSIVE USER INTERFACE FOR AN INDUSTRIAL ENVIRONMENT

(71) Applicant: Rockwell Automation Technologies, Inc., Mayfield Heights, OH (US)

(72) Inventors: Jonathan D. Walter, Broadview Heights, OH (US); Sharon M. Billi-Duran, Euclid, OH (US)

(73) Assignee: Rockwell Automation Technologies, Inc., Mayfield Heights, OH (US)

(21) Appl. No.: 15/004,429

(22) Filed: Jan. 22, 2016

Related U.S. Application Data
(60) Provisional application No. 62/167,705, filed on May 28, 2015.

(51) Int. Cl. G06F 3/0481; G06F 3/14; G06F 3/0484

(52) U.S. Cl. CPC G06F 3/0481; G06F 3/04847; G06F 3/14; G06F 2203/04806

(57) ABSTRACT

The present disclosure describes a method whereby a human machine interface dynamically responds to changes in the display environment actively working to present the most important attributes of a given set of display elements to the user.

### CROSS-REFERENCE TO RELATED APPLICATIONS

This application claims priority to U.S. Provisional Application Ser. No. 62/167,705, filed on May 28, 2015, and entitled “RESPONSIVE USER-INTERFACE FOR AN INDUSTRIAL ENVIRONMENT,” the entirety of which is incorporated herein by reference.

### BACKGROUND

The present invention relates to industrial automation or control systems and in particular to a human machine interface (HMI) used in an industrial control system for the display of data to the user and receiving of inputs from the user of these systems.

A typical industrial automation system is comprised of any number of Industrial controllers or programmable logic controllers (PLC.) Industrial controllers or programmable logic controllers are special purpose computers used for controlling industrial processes or manufacturing equipment. Under the direction of a stored program, the industrial controller examines a series of inputs reflecting the status of the control process and changes outputs affecting the control of the process. The inputs and outputs are a combination of binary that is “on” or “off” and analog inputs and outputs taking on a continuous range of values. The binary inputs and outputs may be represented by single bits of data, the analog inputs and outputs may be represented by multiple bit data words. In order to ease the development and troubleshooting of automation systems these internal data representations are typically given human readable reference names called tags. The input and output data is provided to the industrial controller by input and output devices which are connected to various industrial control devices or components both active and passive, such as sensors, actuators, motors, limit switches, and the like that constitute an industrial control system. Each industrial control devices or components will have one or more important attribute associated with it. These attributes represent information that is important to the proper operation of the industrial automation system. The binary inputs and outputs may be represented by single bits of data. The analog inputs and outputs may be represented by multiple bit data words. In other cases data in a programmable logic controller is represented as a data structure which might contain a combination of single bits of data and multiple bit data words. In this case a tag might contain sub-elements. Each industrial control device or component will have one or more important attributes associated with it. These attributes represent information that is important to the proper operation of the industrial automation system.

In the past the data that characterizes the control process would typically be displayed at a central location, for example on a traditional human machine interface terminal connected to the central processor with the terminal located in a control room thus allowing an operator to monitor and interact with the operation of the process or machine. At times, it may be desirable to have control data or portions of the control data displayed at various locations throughout the factory. Further it may be desirable to allow operators to input data to the control process from these different locations.

Accordingly it is known to incorporate into the control system a number of remote human machine interface (HMI) devices to provide for such input and output at various locations about the factory. Such HMIs include internal programs or applications configured to send and receive data from programs running on one or more programmable logic controllers in order to provide a representation of the control process in using various graphic, textual, or numeric representations of the data or information of an industrial control system.

An industrial human machine interface application is developed by a software application designed for this purpose. An industrial human machine interface development software application typically consists of a development application or environment and a runtime or display application environment. In many cases the development and runtime software applications are purpose built applications that run in a computers operating system but in some cases either or both environments can be hosted in an Internet browser application with data being served from an industrial automation human interface application server in the runtime or display case.

In typical practice an HMI device may be a simple display device providing an indication of the status of the control process, or it may be an industrially hardened computer terminal allowing for both the display of more complex types of control data and for the input by the operator of data. With the advent of improved portable computing devices such as tablets and smartphones and the associated improvement of communications capability it has become increasingly desirable to provide operators with process control information on non-traditional portable computing devices such as tablets and smartphones providing an expanded range of capabilities for industrial human machine interface applications.

Taking all of this into account the ever expanding diversity of portable computing devices available presents a challenge to designers of human machine interface applications. Solutions that work well on large computer systems with large computer displays may not function as well on smaller, mobile devices with potentially less processing resources and display capability. The challenge is to design a human machine interface system that provides scalability across this wide array of platforms.

The advent of a wide array of smaller, more portable connected computing devices allows users of these devices to consume content on a vast number of devices with varying capabilities including display size. In the realm of industrial automation, this provides some challenges. First, it is not efficient to provide photo-realistic depictions of factory machinery data on a small screen. Users do not want to pinch, zoom, and pan across a small screen to view high fidelity representations of an industrial control system. In many cases, users will attempt to create an alternate view for a reduced display size but often find challenges in not having the skills, experience, time, and resources to translate important data from large displays into smaller embodiments for reduced display device capabilities. Second, it is cost prohibitive for users to develop multiple specialized versions of the same application targeting a specific form factor or set of form factors for a small subset of available devices.

### BRIEF DESCRIPTION

The embodiments in the present disclosure provide a human machine interface display management system that delivers optimized display content to a display device based upon display object rendering definition breakpoints describing the form that a display object will take for a given display device capability, display object attribute priority settings which are chosen by the user, and the display device capabilities.

The present disclosure provides a way in which display objects are not simply re-sized, but rather the most important or critical attributes of the data presented in a human machine interface application are identified at design time and these attributes are then used to drive the behavior of the human machine interface application in response to available display device resources. The displayed information is not simply a reduced sized rendering of the data visualization but a form of visualization that presents the most important attributes of the data for the available display device resources such as display size, display resolution, device processor type, device operating system, device memory, or the communications network type and bandwidth available to the display device. This means that the form of the visualization will change as the available resources change always working to present the most important data as identified by the user. The intent is to provide device agnostic human machine interface applications.

### DRAWINGS

These and other features, aspects, and advantages of the present invention will become better understood when the following detailed description is read with reference to the accompanying drawings in which like characters represent like parts throughout the drawings, wherein:

FIG. 1 is a simplified perspective representation of an industrial control system showing programmable logic controllers connected by a data network to human machine interface devices;

FIG. 2 is a block diagram of the components of a programmable logic controller as depicted in FIG. 1 showing a memory holding an application program, an I/O data table, as well as an operating system in addition to a communications module;

FIG. 3 is a block diagram of a human machine interface device showing a memory holding and application program and operating system in addition to a communications module;

FIG. 4 is a table showing an example display object definition;

FIG. 5 is an example human machine interface design application;

FIG. 6 is an example of a configuration screen for a display object used in a human machine interface application;

FIG. 7 is a table showing an example display object configuration;

FIG. 8 is a flowchart of the process of used to determine the rendering of priority attributes to be displayed,

FIG. 9 is a table containing an example of the output from the priority attribute rendering process;

FIG. 10 is a sample representation of an alarm summary screen as seen in a human machine interface application;

FIG. 11 is an example representation of an alarm summary screen for a typical tablet size display; and

FIG. 12 is an example representation of an alarm summary screen for a typical smartphone size display.

### DETAILED DESCRIPTION

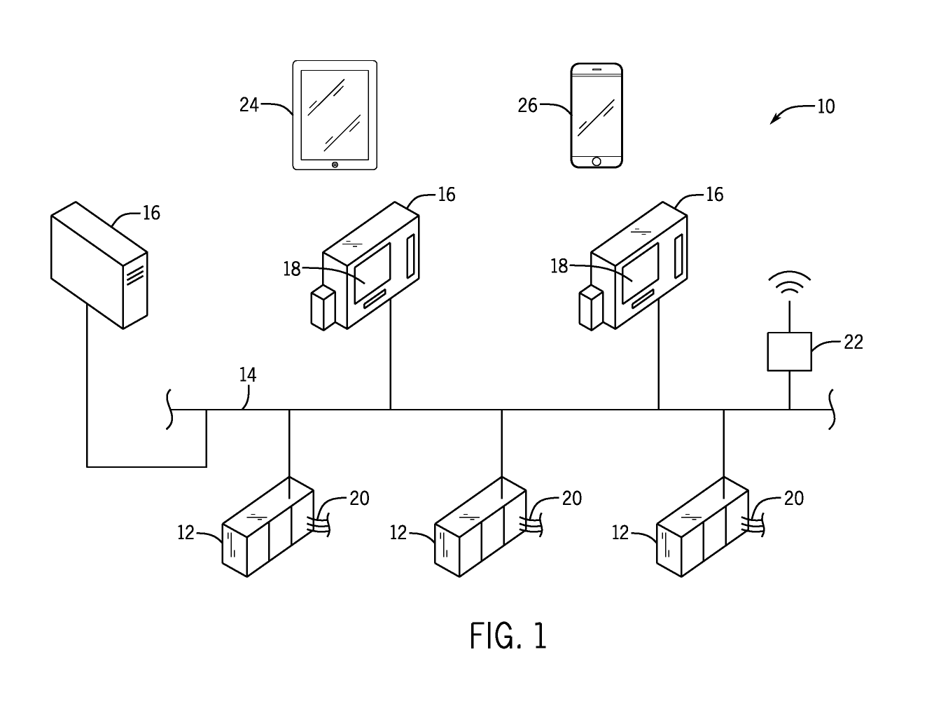

Referring now to FIG. 1, an industrial control system 10 is shown comprising programmable logic controllers 12 connected to I\O interface devices 20 which are connected by various means to any number of industrial automation system components from which input signals are received and output signals returned as part of the control and monitoring of an industrial automation system. Programmable logic controllers 12 are connected to a data network 14 which includes an industrial automation human machine interface (HMI) application server 16 without a display and industrial human machine interface servers 16 with display 18. Data network 14 may also include a network interface device 22 providing wireless network services in addition to connectivity to other data networks including the Internet. Network interface device 22 provides connectivity to the data network 14 for such devices as tablet HMI devices 24 and smartphone HMI devices 26 for the consumption of data and control of the industrial automation system 10.

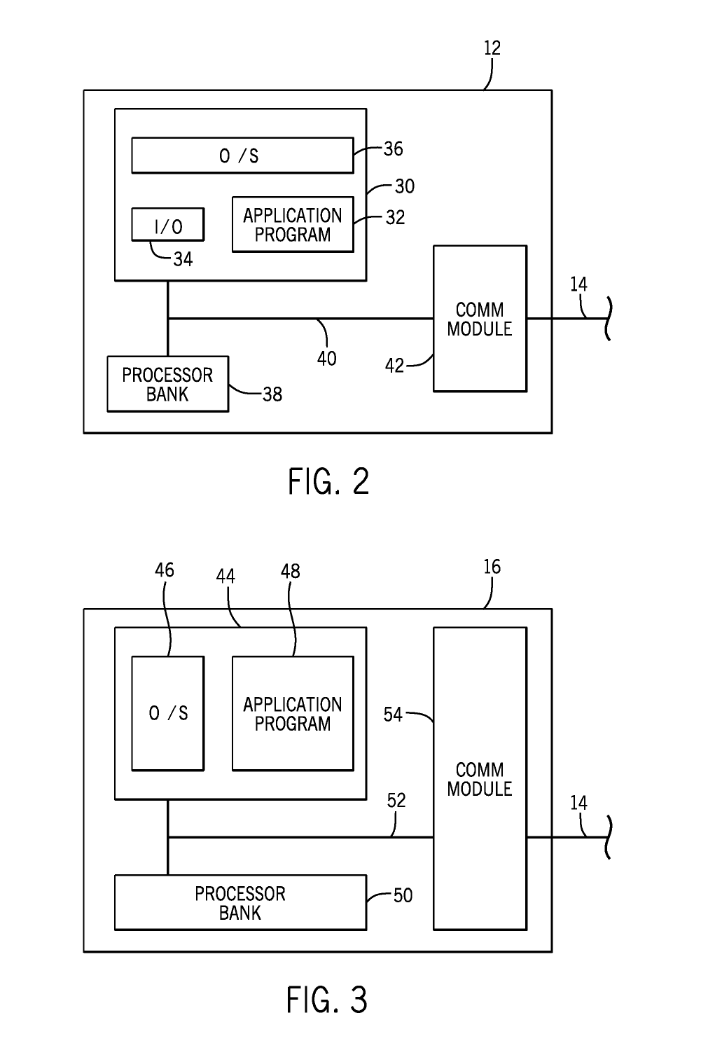

FIG. 2 is a simple block diagram of an industrial controller or programmable logic controller 12 which typically includes a memory 30 holding an application or control program 32, an I/O table 34, and an operating system 36. I\O table 34 is used to store the various input and output signals communicated between the programmable logic controller 12 and the controlled machinery via the I/O modules 20. The input and output data representations are given human readable reference names called tags. The industrial controller or programmable logic controller 12 may include a processor bank 38 communicating on an internal bus 40 to a communications module 42 the latter providing a communications pathway to the data network 14. Also attached to the internal bus 40 is the memory 30. The memory 30 contains one or more application programs 32 including those which produce the outputs to the industrial automation human machine interface (HMI) application server devices 16 both with displays 18 and without displays in addition to tablet HMI devices 24 and smartphone HMI devices 26, and which receive inputs therefrom.

FIG. 3 is a simple block diagram of a typical human machine interface application server 16. It is important to note that in some instances these devices may have a display 18 as shown in FIG. 1. The human machine interface application server 16 may include a processor bank 50 communicating on an internal bus 52 to a communications module 54 the latter providing a communications pathway to the data network 14. Also attached to the internal bus 52 is the memory 44 which holds an operating system 46 and an application program 48 which produces the outputs to the industrial automation human machine interface (HMI) application devices 16 both with displays 18 and without displays in addition to tablet HMI devices 24 and smartphone HMI devices 26 as in FIG. 1, and which receive inputs therefrom. The application program 48 also interfaces with the programmable controllers 12 of industrial automation system 10, receiving outputs from and providing inputs to these devices. The input and output data representations are given human readable reference names called tags.

It is important to note that as in FIG. 1, industrial automation human machine interface (HMI) application devices 16 both with displays 18 and without displays in addition to tablet HMI devices 24 and smartphone HMI devices 26 are embodiments chosen for illustration. In alternate embodiments any device or set of devices encompassing a memory device sufficient for storing graphical data, an output device capable of displaying graphical images or other graphical information, and a processing device with communications capability could suffice. Some devices may operate as both a server and display device and others may simply operate as display devices depending upon the devices capability. In the case of a display device that cannot operate as a server the device allows an operator to view data as well as provide control inputs. Additionally, in the case where the display device is acting only as a display device and not a server the screens of the industrial automation human machine interface (HMI) application may be displayed in a software application dedicated to the purpose of displaying the screens or in an Internet browser application residing on the display device.

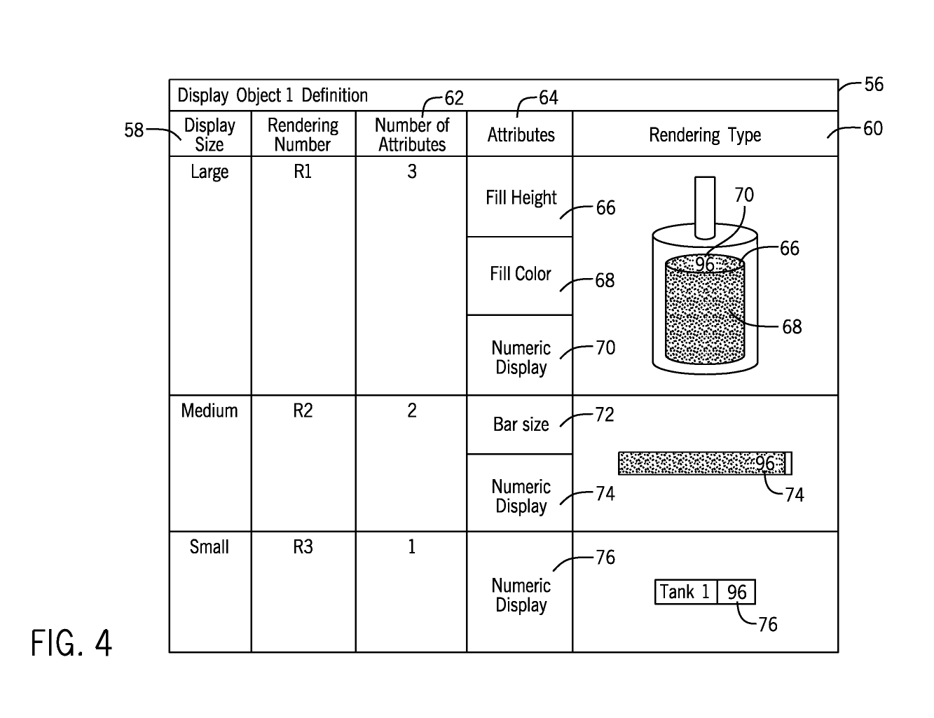

Turning now to FIG. 4, a sample object definition for an HMI display object 56 is shown. In this case the HMI display object 56 is a tank or vessel. The present disclosure provides for the creation of a set of HMI display objects whose definition includes the identification of breakpoints associated with display sizes 58 where each display size has an associated display object rendering 60. Display object breakpoints define the optimal rendering size of a given HMI display object for a given display device capability. Each display object rendering has an associated number of attributes 62 and each attribute has a designation 64 which defines the graphical and or textual form in which the attribute will be displayed typically including display of text or numbers, changes in color, changes in size and shape, changes in position on the screen, changes in the presence or absence of an object among many possible options. Each display object attribute 64 represents an actual data element from the various components of the industrial control system 10. As the display size 58 decreases the number of possible attributes 62 to be displayed decreases as shown. The display object definition 56 provides the definition of how a display object will render for any given display size. In the example of FIG. 4 for a large display breakpoint the tank or vessel display object is defined to have three user configurable attributes 64, fill height 68, and numeric display 70. For a medium display breakpoint the display object is defined to have two user configurable attributes 64, bar size and numeric display in the bar 74, and finally in the case of the small display breakpoint only one attribute 64 is defined, that being numeric display 76. It is important to note that FIG. 4 represents an illustration of an HMI display object. HMI display objects can vary widely in the number of attributes and display renderings that could be defined.

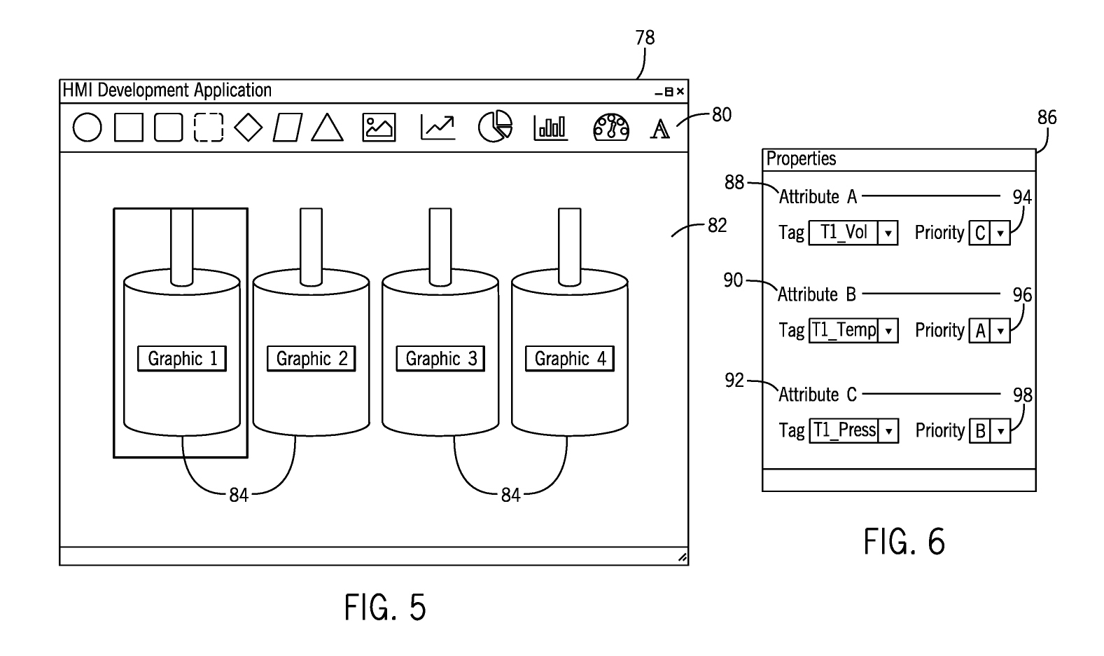

Referring now to FIG. 5 and FIG. 6 the process of HMI application design configuration will be explained. An industrial automation HMI application is typically created by using an industrial automation HMI application development application 78 which provides a development environment and associated tools and objects 80 for the development of an industrial HMI application. An industrial HMI application will typically contain a number of screens 82, each screen configured by the user with a plurality of display objects 84 which in this illustration is a series of tanks or vessels which provide for the display of outputs from the industrial automation system 10 as well as providing means for an operator to provide input to the system 10. An industrial HMI application will receive data from and transmit data to programmable logic controllers 12 as illustrated in FIG. 1. Display object 84 may take the form of a graphic object, a text object, a numeric object, or a table object among many possibilities. For example, for the display object 84 in FIG. 5 the user may wish the height of the graphic fill to represent the volume of material contained in the actual tank, the color of the graphic fill might represent the temperature of the material in the actual tank, and the numeric indicator might represent the pressure or temperature of the material in the actual tank that is being represented by the data in the programmable logic controllers 12 of the industrial control system 10 of FIG. 1.

In reference to FIG. 6, for each display object 84 the HMI application development application 78 will provide a display object configuration screen 86. Each display object 84 may have a unique display object configuration screen 86. Using this screen the person developing the HMI application will associate a human readable reference name or tag from a programmable logic controller 12 to each attribute 88 that is defined for the display object 84. A display object 84 may have a plurality of attributes as represented by 88, 90 and 92 in the example. Each human readable reference name or tag from a programmable logic controller 12 represents a data element of a component of the industrial control system 10. Upon completion of the development of an HMI application the user deploys the application to the human machine interface application server 16.

In the example illustrated in FIG. 6, the data reference or tag “T1_Vol” is associated with attribute A, 88, the data reference or tag “T1_Temp” is associated with attribute B, 90, and the data reference or tag “T1_Press” is associated with attribute C, 92. In addition to the data reference or tag association for each attribute a display priority is assigned to each attribute as indicated by 94, 96, and 98. The display priority setting for each attribute is assigned by the user based upon the critical attribute for a given display object. This piece of information is used to determine the form of rendering for a given display object on a given display device. A user selects this priority setting such that as the display size available for any given display object 84 decreases the most important attribute for a given object will be displayed as determined by the user as opposed to the manner in which a display object 84 is rendered being made solely by the rendering device and available resources at the time of display.

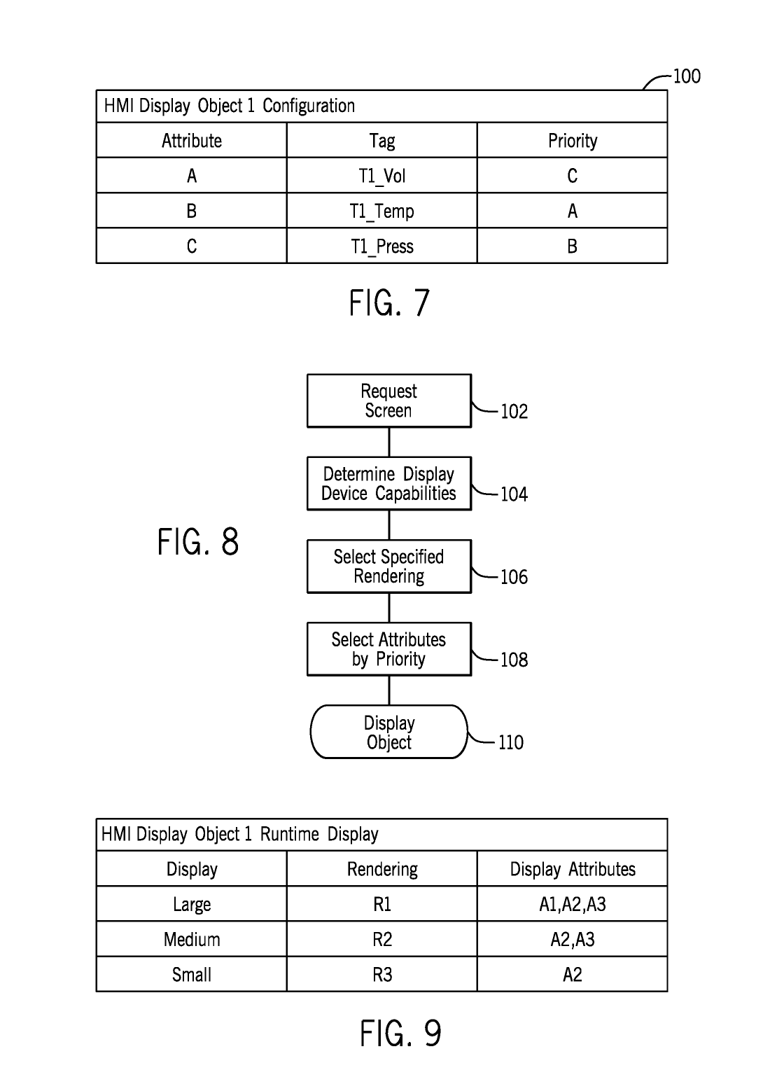

In reference to FIG. 7, an example HMI display object configuration 100 is shown. This is a representation of the results of the configuration process. As illustrated, attribute A of the display object is associated with the tag “T1_Vol” representing the volume of the tank or vessel and is assigned priority C, attribute B is associated with the tag “T1_Temp” and is assigned priority A, and attribute C is associated with the tag “T1_Press” and is assigned priority B. For this example, when the display device breakpoint is at its lowest point priority is given to the temperature of the tank or vessel as represented by the tag “T1_Temp.” This attribute has been designated by the user to be the most critical attribute for the component of the industrial automation system as represented by the data reference or tag associated with it. In an alternate embodiment the prioritization of attributes representing data elements in a programmable logic controller may be configured as part of the development of the application control program residing in the memory of the programmable logic controller. These priority settings would be inherited by the HMI application for the purposes described in this disclosure at the time of the development of the HMI application by simply associating the attributes of HMI display objects with the tags representing the data elements or data structures in the programmable logic controller as previously described.

Turning now to FIG. 8, given an HMI display object definition 56 in FIG. 4, the display object configuration 100 as completed by the user of FIG. 5, and the display device capabilities the rendering of any given display object can be determined. When a display device such as an industrial automation human machine interface (HMI) application device 16 with display 18, a tablet HMI device 24, or a smartphone HMI device 26 as in FIG. 1 requests 102 the display of an HMI application screen 82 the serving device obtains device capability information including display size 104. While device display size is used in this illustration other display device capabilities such as display resolution, device processor type, device operating system, device memory, or the communications network type and bandwidth available to the display device may be utilized as well. Once the display device capability is determined the HMI application will determine the proper rendering 106 based upon the HMI display object definition 56 for a given HMI display object 84. Then the HMI application determines 108 the priority attribute as selected by the user in HMI display object configuration screen 86 for those HMI display objects 84 with multiple attributes as defined by the HMI display object definition 56. This determines 110 the rendering for the display object 84. This process is repeated for each display object on an HMI screen and once all of the display objects 84 have been processed the display objects are displayed on the display devices be that an industrial automation human machine interface (HMI) application device 16 with display 18, a tablet HMI device 24, or a smartphone HMI device 26, as a complete HMI display screen. It is important to note that while the fidelity of the graphics may decrease based upon the display device capability the combination of predefined display objects with renderings based upon display breakpoints used in conjunction with the user defined critical data attribute will work to maintain the highest information or data fidelity for the initial rendering of an HMI screen. In the case where the display device supports re-sizing as directed by user input through the use of pinch to zoom capabilities the rendered HMI display objects 84 will be re-sized based upon the appropriate breakpoint for the re-sized display and the critical data attribute defined by the user.

In addition to the use of the priority attribute for the determination of HMI display object rendering other embodiments may introduce a security component. This security component may take on forms related to user permissions as well as user location in proximity to the industrial control system 10 or a combination of these factors.

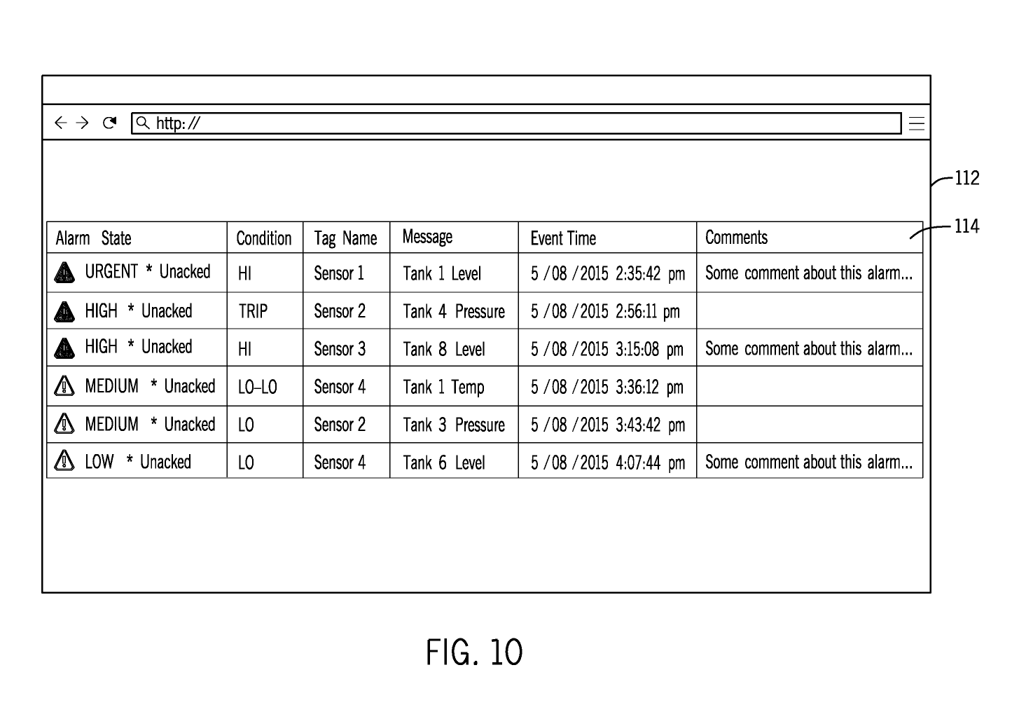

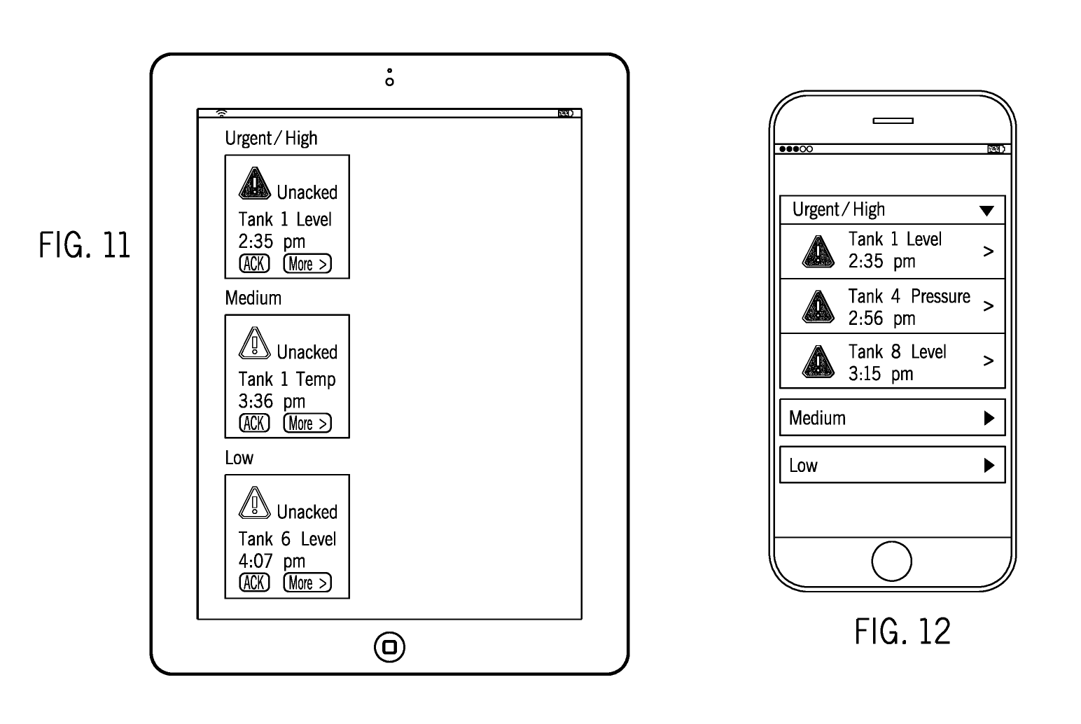

Referring to FIG. 10 an example of an alarm summary screen 112 is provided. The sole display object on this screen is an alarm summary display object 114. While this specification used graphic display objects 84 for illustration it is important to note that the same description applies to display screens 112 that may primarily contain textual data or information such as the alarm summary display object 114. As previously described this particular form of an HMI display object 114 has an HMI object definition that is unique to it. As illustrated in FIG. 11 and FIG. 12 the information associated with the HMI data object, in this case the alarm summary display object 114 is rendered as shown based upon the same set of inputs and process flow as previously described.

While only certain features of the invention have been illustrated and described herein, many modifications and changes will occur to those skilled in the art. It is, therefore, to be understood that the appended claims are intended to cover all such modifications and changes as fall within the true spirit of the invention.

We claim:

1. A non-transitory computer readable medium with computer executable instructions for operating a human machine interface display screen management system, the computer readable medium comprising computer executable instructions for:
determining at least one of the display device capabilities of a display device selected from a list of display size, device processor type, device operating system, device memory, communications network type, or communications network bandwidth;
determining display object rendering definitions based upon predefined breakpoints for each of a plurality of display objects;
determining display object attribute priority settings based upon user definition for each of a plurality of display objects;
comparing display device capability with display object rendering definitions and display object attribute priority settings per display object for each of a plurality of display objects;
selecting the display object rendering per display object for each of a plurality of display objects based upon the display object rendering definition breakpoint, the display object attribute priority settings, and the display device capability for each of a plurality of display objects;
providing each of a plurality of display objects to the display device as a display screen.

2. The system of claim 1 wherein the display device is an industrial automation human machine interface (HMI) device, a tablet computing device, or a smartphone computing device.

3. The system of claim 1 wherein there may be a plurality of display devices.

4. The system of claim 1 wherein the display objects may take the form of a graphic object, a text object, a numeric object, or a table object.

5. The system of claim 4 wherein the display objects are virtual representations of the components, data, and information of an industrial automation system.

6. The system of claim 1 wherein the display objects will have a plurality of breakpoints each breakpoint associated with a specific size and form of a plurality of renderings for the object.

7. The system of claim 6 wherein the specific size and form of each rendering for each display object is optimized for the display size of the display device.

8. The system of claim 1 wherein a display object attribute represents a data element from a component of an industrial automation control system.

9. The system of claim 1 wherein each of a plurality of attributes of a display object is assigned a priority setting.

10. The system of claim 9 wherein the priority settings are hierarchical.

11. The system of claim 9 wherein the priority settings are selected by the user.

12. The system of claim 9 wherein the highest priority is assigned to one attribute identified by the user as the critical display attribute for the display object.

13. The system of claim 1 wherein a change in display size from a pinch to zoom input on a display device will result in the re-sizing of any of a plurality of display objects.

14. A non-transitory computer readable medium with computer executable instructions for operating a human machine interface display screen management system, the computer readable medium comprising computer executable instructions for:
determining at least one of the display device capabilities of a human machine interface device selected from a list of display size and device memory;
determining display object rendering definitions based upon predefined breakpoints for each of a plurality of human machine interface display objects;
determining display object attribute priority settings based upon user definition for each of a plurality of human machine interface display objects;
comparing display device capability with display object rendering definitions and display object attribute priority settings per display object for each of a plurality of human machine interface display objects;
selecting the display object rendering per display object for each of a plurality of human machine interface display objects based upon the display object rendering definition breakpoint, the display object attribute priority settings, and the display device capability for each of a plurality of human machine interface display objects;
providing each of a plurality of human machine interface display objects to the human machine interface device as a display screen.

15. The system of claim 14 wherein the display objects will have a plurality of breakpoints each breakpoint associated with a specific size and form of a plurality of renderings for the object.

16. The system of claim 15 wherein the specific size and form of each rendering for each display object is optimized for the display size of the display device.

17. The system of claim 14 wherein each of a plurality of attributes of a display object is assigned a priority setting by the user.

18. The system of claim 17 wherein the priority settings are hierarchical.

19. The system of claim 17 wherein the highest priority is assigned to one attribute identified by the user as the critical display attribute for the display object.

20. A method for human machine interface display screen management comprising:
defining human machine interface display object renderings based upon breakpoints for each of a plurality of human machine interface display objects where the display objects represent components of an industrial control system;
defining human machine interface display object attributes for each of a plurality of human machine interface display objects where the display objects attributes represent data elements of the components of an industrial control system;
assigning display object attribute priority settings to each attribute of each of a plurality of human machine interface display objects;
determining at least one of the display device capabilities of a display device selected from a list of display size, device processor, device operating system, or device memory;
comparing display device capability with display object rendering definitions and display object attribute priority settings for each of a plurality of display objects;
selecting the display object rendering based upon the display object rendering definition breakpoint, the display object attribute priority settings, and the display device capability for each of a plurality of display objects;
providing a plurality of display objects to the display device as a display screen.
